(19) United States
(12) Patent Application Publication
(10) Pub. No.: US 2025/0207693 A1
(43) Pub. Date: Jun. 26, 2025

(54) MULTILAYER TUBULAR STRUCTURE INTENDED FOR TRANSPORTING A HEAT-TRANSFER FLUID

(71) Applicant: ARKEMA FRANCE, COLOMBES (FR)

(72) Inventors: Nicolas DUFAURE, Serquigny (FR); Marjorie MARCOURT, Serquigny (FR); Claude-Oliver BOISSIERE, Serquigny (FR)

(73) Assignee: ARKEMA FRANCE, COLOMBES (FR)

(21) Appl. No.: 18/844,827

(22) PCT Filed: Mar. 8, 2023
(86) PCT No.: PCT/FR2023/050314

§ 371 Date: Sep. 6, 2024

(30) Foreign Application Priority Data
Mar. 9, 2022 (FR) FR2202036

(51) Int. Cl. F16L 11/04

(52) U.S. Cl. CPC F16L 11/045; F16L 2011/047

(57) ABSTRACT

A multilayer tubular structure for transporting a heat transfer fluid, the multilayer tubular structure including: at least one layer (1) including a composition (1) including at least one long-chain polyamide (PA) having from 10 to 15 carbon atoms per nitrogen atom and including at least 50% of aliphatic units relative to the sum of the units present in said long-chain polyamide, at least one layer (2) located below said layer (1), including a composition (2) including at least one polyamide having from 4 to 9 carbon atoms per nitrogen atom, at least one layer (3) including a composition (3) including a hydrophobic polymer, a layer (4) including either a composition (4) including a PA6, a PA66 or a mixture thereof, from 5% to 50% by weight of at least one polyolefin, or a composition (4′) including at least one C8-C14 aliphatic polyamide, the layer (4) in contact with the fluid transported.

### TECHNICAL FIELD

The present patent application relates to a multilayer tubular structure (MLT) intended for transporting a heat transfer fluid and to its use for transporting heat transfer fluid, more particularly refrigerant fluid chosen from hydrocarbon compounds, hydrofluorocarbons, ethers, hydrofluoroethers, CO₂, NH₃, SO₂ and fluoroolefins, in particular R134, R-1234yf or R-1234ze, more particularly R-1234yf or R-1234ze in the field of automotive air conditioning.

### PRIOR ART

Tubular structures for transporting heat transfer fluid in the field of automotive air conditioning require two conflicting properties, which are, respectively, water permeability and hot bursting (125° C.) which must be greater than 83 bar.

Thus, long-chain polyamides enable compliance with the first property, which therefore makes the use of short-chain polyamides unsuitable for this first property.

Nevertheless, these same short-chain polyamides enable resistance to hot bursting, which therefore makes the use of long-chain polyamides unsuitable for this second property.

In addition, the European F-Gas directive schedules a gradual withdrawal from the market of refrigerant gases having high global warming potential (GWP). From 100% in 2015, the quantity of high-GWP hydrofluorocarbon (HFC) refrigerants is required to decrease to 63% between 2018 and 2020 before reaching 21% in 2030.

Since January 2017, new motor vehicles marketed in Europe have had to be OEM-fitted with air conditioning running on R1234yf.

However, this standard is currently only valid at European level, but will likely be extended in the short term to other geographical zones such as the USA.

Air conditioning circuit elements, and multilayer tubular structures in particular, must also:
be impervious to the transported fluids and therefore have barrier properties with respect to these fluids (and more particularly to fluorocarbon refrigerant compounds such as R134, R-1234yf or R-1234ze), and also to water and to oxygen. The term “barrier properties” means that the structure is virtually impermeable to the fluids of the automotive air conditioning lines and therefore allows virtually no air conditioning line fluids to be emitted into the atmosphere.
have chemical resistance to the transported fluids, and also to compressor oils, water and oxygen, in order to avoid excessive degradation over the long term;
have not only sufficient mechanical strength (more particularly bursting strength) but also sufficient flexibility in the case where the two ends of the tube are connected to parts that can move relative to each other (more particularly in automotive air conditioning, where space and under-hood mounting constraints require the tubular structures to be bent) and allow vibration damping;
have satisfactory thermal resistance, taking account of the fact that the fluids transported may be at a high temperature, and that the temperature of the environment may also be high (more particularly in automotive air conditioning, where the parts concerned may be sited in the vicinity of the engine) and in particular to ZnCl₂.

The current lines consist of one part in aluminum, and of another in rubber with reinforcing braid and barrier layer.

Tubular solutions made of thermoplastic are therefore envisaged to replace the current lines in order to reduce the weight of the vehicles.

Hence international application WO2020/115420 describes, inter alia, a multilayer tubular structure of aliphatic polyamides for transporting refrigerant fluid.

International application WO2017/103466 describes multilayer tubular structures for transporting refrigerant fluid. The mechanical properties are provided by a layer consisting of a mixture of semicrystalline thermoplastic and of continuous fibers.

International application WO2014/125219 describes tubular structures comprising at least one layer consisting of a composition comprising a copolyamide of formula X/10·T/Y. The proportion of units X is from 0.4 to 0.8 mol per mole of semi-aromatic units 10·Y

Hutchinson has also marketed air conditioning lines consisting of an alloy of PA6 and PA66, but these lines encounter significant problems, more particularly an excessively high permeability to water, inducing corrosion of the compressors.

TI Fluid Systems has also developed a solution consisting of a PA612 layer and a PA11/10T layer internally.

Evonik offers grades of PA610 and PA612 to make single-layer air conditioning lines.

Aside from transport of refrigerant fluid, patents EP2098580, EP2098365, WO2014/114766 and WO2017/121961 describe thermoplastic tubular structures for transporting gasoline and in particular alcoholic gasoline.

However, none of these technical solutions make it possible to meet all of the needs expressed by the automotive manufacturers.

The present invention therefore relates to a multilayer tubular structure (MLT) for transporting a heat transfer fluid, said multilayer tubular structure comprising:
at least one layer (1) comprising a composition (1) comprising predominantly
at least one long-chain polyamide (PA) having from 10 to 15 carbon atoms per nitrogen atom and comprising at least 50% of aliphatic units relative to the sum of the units present in said long-chain polyamide,
at least one layer (2) located below said layer (1), comprising a composition (2) comprising predominantly at least one polyamide having from 4 to 9 carbon atoms per nitrogen atom, said polyamide comprising at least 50% of aliphatic units relative to the sum of the units present in said polyamide, more particularly said composition (2) comprising up to 12% by weight of polyolefins, in particular up to 6% by weight of polyolefin, relative to the total weight of said composition (2), and up to 2% by weight of at least one plasticizer, relative to the total weight of said composition (2),
at least one layer (3) comprising a composition (3) comprising predominantly a hydrophobic polymer, more particularly a polypropylene or a polyethylene, more particularly said layer (3) being located below said layer (2) or between said layer (1) and said layer (2),
a layer (4) comprising either a composition (4) comprising a PA6, a PA66 or a mixture thereof, from 5% to 50% by weight of at least one polyolefin, more particularly a functionalized polyolefin, preferably from 10% to 40% by weight of at least one polyolefin, up to 2% by weight of at least one plasticizer and up to 2% by weight of an additive, relative to the total weight of said composition (4)
or a composition (4′) comprising predominantly at least one C8-C14 aliphatic polyamide,
said layer (4) in contact with said fluid transported,
and the thickness of said layer or layers (2) representing at least 70% of the total thickness of the tube.

The inventors have therefore found, unexpectedly, that the multilayer tubular structure of the invention comprising at least four layers makes it possible to meet all the needs expressed by automotive manufacturers, namely barrier properties to the refrigerant fluid and in particular to R1234yf provided by a PA6 modified with a polyolefin or a PA having from eight to fourteen carbon atoms per nitrogen atom, properties of low water permeability provided by the hydrophobic polymer, whereas the PAs have a water permeability which is too high relative to the requirements of the application, properties of hot bursting resistance provided by the short and medium-chain PAs (from four to nine carbon atoms per nitrogen atom), and which make it possible to obtain a compromise in weight and mechanical performance, and finally properties of resistance to ZnCl₂ provided by the long-chain PAs in the outer layer, and which ensure good resistance to stress cracking.

According to one embodiment, the multilayer tubular structures of the invention advantageously have barrier properties to the refrigerant fluid and in particular to R1234yf, meeting classification C according to the GMW 14319 standard.

According to one embodiment, the multilayer tubular structures of the invention advantageously have a zinc chloride resistance corresponding to classification 1 (the outer surface of the tubes is intact (no cracks) and the bursting pressure is unchanged) according to the protocol described in the examples.

According to one embodiment, the multilayer tubular structures of the invention advantageously have a bursting stress at 125° C. of greater than or equal to 12 MPa according to DIN 53758 SAE J3062, as described in the examples.

According to one embodiment, the multilayer tubular structures of the invention advantageously have a water permeability of less than 23 g/m2.24 h according to the materials test method D45.1720 of PSA Peugeot Citroën as described in the examples.

### With Regard to Layer (1) and Composition (1)

The expression “comprising predominantly at least one polyamide” means that the one or more polyamides are present in the composition (1) in a proportion by weight of more than 50% relative to the total weight of the composition.

The term “polyamide” denotes both a homopolyamide and a copolyamide.

The nomenclature used to define polyamides is described in standard ISO 1874-1:2011 “Plastics—Polyamide (PA) moulding and extrusion materials—Part 1: Designation”, in particular on page 3 (tables 1 and 2) and is well known to those skilled in the art.

The homopolyamide can be obtained from the polycondensation of lactam units, amino acid units or units XY, X being a diamine and Y a dicarboxylic acid (or diacid), from the point at which the homopolyamide has from 10 to 15 carbon atoms per nitrogen atom.

The diamine may be linear or branched aliphatic, or cycloaliphatic, and is preferably linear or branched aliphatic, in particular linear aliphatic.

The dicarboxylic acid may be aliphatic or cycloaliphatic, and preferably aliphatic.

Consequently, the lactams and amino acids used to obtain the homopolyamides must have an average number of carbon atoms (C) per nitrogen atom (N) of from 10 to 15.

Advantageously, the lactams and the amino acids are C11 and C12.

In the case of homopolyamides obtained from the polycondensation of units XY, the number of atoms per nitrogen atom is calculated by the average of the numbers of carbon atoms present in the unit derived from the diamine X and in the unit derived from the diacid Y.

Therefore, the diamine (X) can be C4 to C36, especially C6 to C18, more particularly C4 to C12, and the dicarboxylic acid (Y) can be C4 to C36, especially C6 to C18, more particularly C6 to C12, from the point at which the average of the numbers of carbon atoms present in the unit derived from the diamine X and in the unit derived from the diacid Y is from 10 to 15.

Advantageously, the diamine is chosen from 2-methyl-1,5-pentanediamine, 1,6-hexamethylenediamine, 1,7-heptanediamine, 1,8-octanediamine, 1,9-nonanediamine, 2-methyl-1,8-octane-diamine, 2,2,4-trimethylhexamethylenediamine, 2,4,4-trimethylhexamethylenediamine, 1,10-decanediamine, 1,11-undecanediamine, 2-butyl-2-ethyl-1,5-pentanediamine, 1,12-dodecanediamine, 1,13-tridecanediamine, 1,14-tetradecanediamine, 1,16-hexadecanediamine and 1,18-octadecanediamine.

Advantageously, the diamine is chosen from 1,10-decanediamine and 1,12-dodecanediamine.

Advantageously, the dicarboxylic acid is chosen from sebacic acid and dodecanedioic acid.

Advantageously, the diamine is chosen from 1,10-decanediamine and 1,12-dodecanediamine and the dicarboxylic acid is chosen from sebacic acid, undecanedioic acid and dodecanedioic acid.

In the case of copolyamides, the number of carbon atoms per nitrogen atom is calculated according to the same principle as for a homopolyamide. The calculation is carried out on a molar pro rata basis from the various amide units.

Consequently, the lactams and the amino acids used to obtain the copolyamides can have an average number of carbon atoms (C) per nitrogen atom (N) of from 6 to 15.

The diamines X and diacids Y used in the copolyamides may be aromatic diamines and/or diacids from the point at which said polyamide of the composition (1) comprises at least 50% of aliphatic units relative to the sum of the units present in said polyamide.

In one embodiment, said at least one polyamide of the composition (1) comprises at least 60% of aliphatic units relative to the sum of the units present in said polyamide.

In another embodiment, said at least one polyamide of the composition (1) comprises at least 70% of aliphatic units relative to the sum of the units present in said polyamide. In another embodiment, said at least one polyamide of the composition (1) comprises at least 80% of aliphatic units relative to the sum of the units present in said polyamide.

In another embodiment, said at least one polyamide of the composition (1) comprises at least 90% of aliphatic units relative to the sum of the units present in said polyamide.

In another embodiment, said at least one polyamide of the composition (1) comprises 100% of aliphatic units relative to the sum of the units present in said polyamide.

Advantageously, said at least one polyamide of the composition (1) consists solely of aliphatic units.

In one embodiment, said composition (1) comprises predominantly a single polyamide and therefore said single polyamide is present in the composition in a proportion by weight of more than 50% relative to the total weight of the composition.

In one embodiment, said polyamide of the composition (1) comprises at least 60% of aliphatic units relative to the sum of the units present in said polyamide.

In another embodiment, said polyamide of the composition (1) comprises at least 70% of aliphatic units relative to the sum of the units present in said polyamide.

In another embodiment, said polyamide of the composition (1) comprises at least 80% of aliphatic units relative to the sum of the units present in said polyamide.

In another embodiment, said polyamide of the composition (1) comprises at least 90% of aliphatic units relative to the sum of the units present in said polyamide.

In another embodiment, said polyamide of the composition (1) comprises 100% of aliphatic units relative to the sum of the units present in said polyamide. Said polyamide of the composition (1) therefore consists solely of aliphatic units.

In one embodiment, said layer (1) consists of a composition (1) comprising predominantly at least one long-chain polyamide having from 10 to 15 carbon atoms per nitrogen atom and comprising at least 50% of aliphatic units relative to the sum of the units present in said long-chain polyamide.

In one embodiment, said at least one polyamide of the composition (1) comprises at least 60% of aliphatic units relative to the sum of the units present in said polyamide.

In another embodiment, said at least one polyamide of the composition (1) comprises at least 70% of aliphatic units relative to the sum of the units present in said polyamide.

In another embodiment, said at least one polyamide of the composition (1) comprises at least 80% of aliphatic units relative to the sum of the units present in said polyamide.

In another embodiment, said at least one polyamide of the composition (1) comprises at least 90% of aliphatic units relative to the sum of the units present in said polyamide.

In another embodiment, said at least one polyamide of the composition (1) comprises 100% of aliphatic units relative to the sum of the units present in said polyamide. Said polyamide therefore consists solely of aliphatic units.

In one embodiment, said layer (1) consists of a composition (1) comprising predominantly a single polyamide and therefore said single polyamide is present in the composition in a proportion by weight of more than 50% relative to the total weight of the composition.

In one embodiment, said polyamide of the composition (1) comprises at least 60% of aliphatic units relative to the sum of the units present in said polyamide.

In another embodiment, said polyamide of the composition (1) comprises at least 70% of aliphatic units relative to the sum of the units present in said polyamide.

In another embodiment, said polyamide of the composition (1) comprises at least 80% of aliphatic units relative to the sum of the units present in said polyamide.

In another embodiment, said polyamide of the composition (1) comprises at least 90% of aliphatic units relative to the sum of the units present in said polyamide.

In another embodiment, said polyamide of the composition (1) comprises 100% of aliphatic units relative to the sum of the units present in said polyamide. Said polyamide of the composition (1) therefore consists solely of aliphatic units.

Advantageously, in all the embodiments defined above for the composition (1) of the layer (1), the lactam is chosen from lauryllactam, the amino acid is chosen from aminoundecanoic acid, the diamine is chosen from 1,8-octanediamine, 1,9-nonanediamine, 2-methyl-1,8-octanediamine, 2,2,4-trimethylhexamethylenediamine, 2,4,4-trimethylhexamethylenediamine, 1,10-decanediamine, 1,11-undecanediamine, 2-butyl-2-ethyl-1,5-pentanediamine and 1,12-dodecanediamine and the dicarboxylic acid is chosen from suberic acid, azelaic acid, sebacic acid, undecanedioic acid, dodecanedioic acid, brassylic acid and tetradecanedioic acid.

More advantageously, the lactam is lauryllactam, the amino acid is aminoundecanoic acid, the diamine is chosen from 1,10-decanediamine and 1,12-dodecanediamine, and the dicarboxylic acid is chosen from sebacic acid and dodecanedioic acid.

Said composition (1) may also comprise at least one polyolefin.

Said composition (1) can therefore comprise, in addition to said at least one polyamide, at least one polyolefin.

The polyolefin may be functionalized or nonfunctionalized or be a mixture of at least one functionalized and/or at least one nonfunctionalized. To simplify, the polyolefin has been denoted (B) and functionalized polyolefins (B1) and non-functionalized polyolefins (B2) have been described below.

A non-functionalized polyolefin (B2) is conventionally a homopolymer or copolymer of alpha-olefins or diolefins, for instance ethylene, propylene, 1-butene, 1-octene or butadiene. Examples that may be mentioned include:
polyethylene homopolymers and copolymers, more particularly LDPE, HDPE, PE-RT LLDPE (linear low density polyethylene), VLDPE (very low density polyethylene) and metallocene polyethylene;
propylene homopolymers or copolymers;
ethylene/alpha-olefin such as ethylene/propylene, EPR (abbreviation for ethylene-propylene-rubber) and ethylene/propylene/diene (EPDM) copolymers;
styrene/ethylene-butene/styrene (SEBS), styrene/butadiene/styrene (SBS), styrene/isoprene/styrene (SIS) and styrene/ethylene-propylene/styrene (SEPS) block copolymers;
copolymers of ethylene with at least one product chosen from salts or esters of unsaturated carboxylic acids, such as alkyl (meth)acrylate (for example methyl acrylate), or vinyl esters of saturated carboxylic acids, such as vinyl acetate (EVA), it being possible for the proportion of comonomer to be up to 40% by weight.

The functionalized polyolefin (B1) may be a polymer of alpha olefins bearing reactive units (the functionalities); such reactive units are acid, anhydride or epoxy functions. By way of example, mention may be made of the preceding polyolefins (B2) grafted or copolymerized or terpolymerized with unsaturated epoxides, such as glycidyl (meth)acrylate, or with carboxylic acids or the corresponding salts or esters, such as (meth)acrylic acid (it being possible for the latter to be completely or partially neutralized with metals such as Zn, and the like), or else with carboxylic acid anhydrides, such as maleic anhydride. A functionalized polyolefin is, for example, a PE/EPR mixture, the weight ratio of which can vary within broad limits, for example between 40/60 and 90/10, said mixture being cografted with an anhydride, notably maleic anhydride, in a degree of grafting of, for example, from 0.01 to 5% by weight.

The functionalized polyolefin (B1) may be chosen from the following (co) polymers, grafted with maleic anhydride or glycidyl methacrylate, in which the degree of grafting is, for example, from 0.01% to 5% by weight:
PE, PP, copolymers of ethylene with propylene, butene, hexene or octene containing, for example, from 35% to 80% by weight of ethylene;
ethylene/alpha-olefin such as ethylene/propylene, EPR (abbreviation for ethylene-propylene-rubber) and ethylene/propylene/diene (EPDM) copolymers;
styrene/ethylene-butene/styrene (SEBS), styrene/butadiene/styrene (SBS), styrene/isoprene/styrene (SIS) and styrene/ethylene-propylene/styrene (SEPS) block copolymers;
copolymers of ethylene and vinyl acetate (EVA), containing up to 40% by weight of vinyl acetate;
copolymers of ethylene and alkyl (meth)acrylate, containing up to 40% by weight of alkyl (meth)acrylate;
copolymers of ethylene and vinyl acetate (EVA) and alkyl (meth)acrylate, containing up to 40% by weight of comonomers.

The functionalized polyolefin (B1) may also be chosen from ethylene/propylene copolymers, predominant in propylene, grafted with maleic anhydride and then condensed with monoaminated polyamide (or polyamide oligomer) (products described in EP-A-0342066).

The functionalized polyolefin (B1) may also be a copolymer or terpolymer of at least the following units: (1) ethylene, (2) alkyl (meth)acrylate or saturated carboxylic acid vinyl ester and (3) anhydride such as maleic anhydride, or (meth)acrylic acid, or epoxy, such as glycidyl (meth)acrylate.

As examples of functionalized polyolefins of the latter type, mention may be made of the following copolymers, where ethylene preferably represents at least 60% by weight and where the termonomer (the function) represents, for example, from 0.1% to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the preceding copolymers, the (meth)acrylic acid can be salified with Zn or Li.

The term “alkyl (meth)acrylate” in (B1) or (B2) denotes C1-C8 alkyl methacrylates and acrylates and may be chosen from methyl acrylate, ethyl acrylate, n-butyl acrylate, isobutyl acrylate, 2-ethylhexyl acrylate, cyclohexyl acrylate, methyl methacrylate and ethyl methacrylate.

Moreover, the abovementioned polyolefins (B1) may also be crosslinked via any suitable process or agent (diepoxy, diacid, peroxide, etc.); the term “functionalized polyolefin” also includes mixtures of the abovementioned polyolefins with a difunctional reagent such as diacid, dianhydride, diepoxy, etc. that is capable of reacting with these polyolefins or mixtures of at least two functionalized polyolefins which can react together.

The abovementioned copolymers, (B1) and (B2), can be copolymerized in random or block fashion and may have a linear or branched structure.

The molecular weight, the MFI index and the density of these polyolefins may also vary within a broad range, which will be perceived by a person skilled in the art. MFI is the abbreviation for the Melt Flow Index. It is measured according to the standard ASTM 1238.

The nonfunctionalized polyolefins (B2) are advantageously chosen from polypropylene homopolymers or copolymers, and any ethylene homopolymer, or copolymer of ethylene and of a comonomer of higher alpha-olefin type, such as butene, hexene, octene or 4-methyl-1-pentene. Mention may be made, for example, of PPs, high density PEs, medium density PEs, linear low density PEs, low density PEs or very low density PEs. These polyethylenes are known to those skilled in the art as being produced according to a “radical” process, according to a “Ziegler”-type catalysis or, more recently, according to a “metallocene” catalysis.

Advantageously, the functionalized polyolefins (B1) are chosen from any polymer comprising alpha-olefinic units and units carrying polar reactive functions such as epoxy, carboxylic acid or carboxylic acid anhydride functions. As examples of such polymers, mention may be made of the terpolymers of ethylene, alkyl acrylate and maleic anhydride or glycidyl methacrylate, such as Lotader® (SK functional polymer) products or polyolefins grafted with maleic anhydride, such as Orevac® (SK functional polymer) products from the applicant, and also terpolymers of ethylene, alkyl acrylate and (meth)acrylic acid. Mention may also be made of polypropylene homopolymers or copolymers grafted with a carboxylic acid anhydride and then condensed with polyamides or monoamino oligomers of polyamide.

Advantageously, the polyolefin is an impact modifier. The impact modifier advantageously consists of a polymer with a flexural modulus of less than 100 MPa measured according to the standard ISO 178:2010, determined at 23° C. with a relative humidity: RH50%, and Tg less than 0° C. (measured according to standard 11357-2:2013 at the inflection point of the DSC thermogram).

Advantageously, said composition (1) comprises up to 40% by weight of at least one polyolefin.

Advantageously, said composition (1) comprises at least 3% by weight of at least one polyolefin, more particularly at least 6% by weight of at least one polyolefin, more particularly from 6% to 20% by weight, in particular from 10% to 12% by weight of at least one polyolefin, relative to the total weight of said composition (1).

Said composition (1) may also comprise at least one plasticizer.

Said composition (1) may therefore comprise, in addition to said at least one polyamide, at least one plasticizer.

By way of example, the plasticizers are chosen from benzenesulfonamide derivatives, such as n-butylbenzenesulfonamide (BBSA), ethyltoluenesulfonamide or N-cyclohexyltoluenesulfonamide; hydroxybenzoic esters, such as 2-ethylhexyl parahydroxybenzoate and 2-decylhexyl parahydroxybenzoate; esters or ethers of tetrahydrofurfuryl alcohol, such as oligoethyleneoxytetrahydrofurfuryl alcohol; and esters of citric acid or hydroxymalonic acid, such as oligoethyleneoxy malonate.

It would not be departing from the scope of the invention to use a mixture of plasticizers.

Advantageously, said composition (1) comprises up to 8% by weight of at least one plasticizer relative to the weight of said composition (1).

In another embodiment, said composition (1) is free from plasticizer.

Said composition (1) may also comprise an additive.

The additives optionally used in the compositions of the invention are the conventional additives used in polyamides and well known to those skilled in the art and are described in particular in EP 2098580.

For example, they comprise an antistatic filler chosen from carbon black, graphite, carbon fibers, carbon nanotubes, more particularly carbon black and carbon nanotubes, an antioxidant, a heat stabilizer, a UV absorber, a light stabilizer, a lubricant, an inorganic filler, a flame retardant, a nucleating agent and a dye, reinforcing fibers, a wax and mixtures thereof.

By way of example, the stabilizer may be a UV stabilizer, an organic stabilizer or more generally a combination of organic stabilizers, such as an antioxidant of phenol type (for example of the type of Irganox® 245 or 1098 or 1010 from Ciba-BASF), or an antioxidant of phosphite type (for example Irgafos® 126 or Irgafos® 168 from Ciba-BASF) and even optionally other stabilizers such as a HALS, which means hindered amine light stabilizer (for example Tinuvin® 770 from Ciba-BASF), an anti-UV agent (for example Tinuvin® 312 from Ciba) or a phosphorus-based stabilizer. Use may also be made of antioxidants of amine type such as Naugard® 445 from the company Crompton or else of polyfunctional stabilizers such as Nylostab® S-EED from the company Clariant.

This stabilizer may also be a mineral stabilizer, such as a copper-based stabilizer. Examples of such mineral stabilizers include copper halides and acetates. Secondarily, other metals such as silver may possibly be considered, but these are known to be less effective. These copper-based compounds are typically combined with halides of alkali metals, more particularly potassium.

In one embodiment, said composition (1) comprises by weight:
60% to 100% of at least one C10 to C15 long-chain polyamide as defined above;
0 to 30% of at least one polyolefin;
0 to 8% of at least one plasticizer;
0 to 2% of at least one additive, the total being 100% by weight.

In another embodiment, said composition (1) comprises by weight:
60% to 97% of at least one C10 to C15 long-chain polyamide as defined above;
3 to 30% of at least one polyolefin;
0 to 8% of at least one plasticizer;
0 to 2% of at least one additive,
   the total being 100% by weight.

In another embodiment, said composition (1) comprises by weight:
70% to 94% of at least one C10 to C15 long-chain polyamide as defined above;
6 to 20% of at least one polyolefin;
0 to 8% of at least one plasticizer;
0 to 2% of at least one additive,
   the total being 100% by weight.

Advantageously, said composition (1) is free from plasticizer and said composition (1) comprises by weight:
50% to 100% of at least one C10 to C15 long-chain polyamide as defined above;
0 to 40% of at least one polyolefin,
from 0 to 8% of a plasticizer,
0 to 2% of at least one additive,
   the total being 100% by weight.

More advantageously, said composition (1) comprises by weight:
60% to 97% of at least one C10 to C15 long-chain polyamide as defined above;
3 to 30% of at least one polyolefin;
from 0 to 8% of a plasticizer,
0 to 2% of at least one additive,
   the total being 100% by weight.

Even more advantageously, said composition (1) comprises by weight:
70% to 94% of at least one C10 to C15 long-chain polyamide as defined above;
6 to 20% of at least one polyolefin;
from 0 to 8% of a plasticizer,
0 to 2% of at least one additive,
   the total being 100% by weight.

More particularly, said composition (1) comprises by weight:
78% to 90% of at least one C10 to C15 long-chain polyamide as defined above;
10 to 12% of at least one polyolefin;
from 0 to 8% of a plasticizer,
0 to 2% of at least one additive,
   the total being 100% by weight.

The present invention also covers the various embodiments of the composition (1) in which the term “comprising” is replaced by the term “consisting of”.

It is quite obvious that the various compositions (1) comprising or not comprising at least one polyolefin and/or at least one plasticizer and/or at least one additive refer to all the embodiments described above.

In one embodiment, said at least one polyamide of the layer (1) of the tubular structure defined above is chosen from PA11, PA12, PA1010, PA1012, PA1210 and PA1212.

The layer (1) of the tubular structure defined above may be the outermost layer. Advantageously, said layer (1) of the tubular structure defined above is the outermost layer of said structure.

Advantageously, said structure (1) comprises a single layer (1).

### With Regard to Layer (2) and Composition (2)

The expression “comprising predominantly at least one polyamide” is as defined above for the layer (1).

The term “polyamide” designates in the same way both a homopolyamide and a copolyamide.

The homopolyamide can be obtained from the polycondensation of lactam units, amino acid units or units XY, X being a diamine and Y a dicarboxylic acid (or diacid), from the point at which the homopolyamide has from 4 to 9 carbon atoms per nitrogen atom.

The diamine may be linear or branched aliphatic, or cycloaliphatic, and is preferably linear or branched aliphatic, in particular linear aliphatic.

The dicarboxylic acid may be aliphatic or cycloaliphatic, and preferably aliphatic. Consequently, the lactams and amino acids used to obtain the homopolyamides must have an average number of carbon atoms (C) per nitrogen atom (N) of from 4 to 9.

Advantageously, the lactams and the amino acids are C6.

In the case of homopolyamides obtained from the polycondensation of units XY, the number of atoms per nitrogen atom is calculated by the average of the numbers of carbon atoms present in the unit derived from the diamine X and in the unit derived from the diacid Y.

Therefore, the diamine (X) can be C4 to C14, especially C4 to C12, more particularly C4 to C10, and the dicarboxylic acid (Y) can be C4 to C14, especially C4 to C12, more particularly C4 to C10, from the point at which the average of the numbers of carbon atoms present in the unit derived from the diamine X and in the unit derived from the diacid Y is from 4 to 9.

Advantageously, the diamine is chosen from butanediamine, pentanediamine, 2-methyl-1,5-pentanediamine, 1,6-hexamethylenediamine, 1,7-heptanediamine, 1,8-octanediamine, 1,9-nonanediamine, 2-methyl-1,8-octane-diamine, 2,2,4-trimethylhexamethylenediamine, 2,4,4-trimethylhexamethylenediamine, 1,10-decanediamine, 1,11-undecanediamine, 2-butyl-2-ethyl-1,5-pentanediamine, 1,12-dodecanediamine, 1,13-tridecanediamine, 1,14-tetradecanediamine, in particular 1,6-hexamethylenediamine.

Advantageously, the dicarboxylic acid is chosen from succinic acid, pentanedioic acid, adipic acid, suberic acid, azelaic acid, sebacic acid, undecanedioic acid, dodecanedioic acid, brassylic acid, tetradecanedioic acid, in particular sebacic acid and dodecanedioic acid.

Advantageously, the diamine is chosen from butanediamine, pentanediamine, 2-methyl-1,5-pentanediamine, 1,6-hexamethylenediamine, 1,7-heptanediamine, 1,8-octanediamine, 1,9-nonanediamine, 2-methyl-1,8-octanediamine, 2,2,4-trimethylhexamethylenediamine, 2,4,4-trimethylhexamethylenediamine, 1,10-decanediamine, 1,11-undecanediamine, 2-butyl-2-ethyl-1,5-pentanediamine, 1,12-dodecanediamine, 1,13-tridecanediamine and 1,14-tetradecanediamine, in particular 1,6-hexamethylenediamine, and the dicarboxylic acid is chosen from succinic acid, pentanedioic acid, adipic acid, suberic acid, azelaic acid, sebacic acid, undecanedioic acid, dodecanedioic acid, brassylic acid and tetradecanedioic acid, in particular sebacic acid and dodecanedioic acid.

The diamines X and diacids Y used in the copolyamides may be aromatic diamines and/or diacids from the point at which said polyamide of the composition (2) comprises at least 50% of aliphatic units relative to the sum of the units present in said polyamide.

In one embodiment, said at least one polyamide of the composition (2) comprises at least 60% of aliphatic units relative to the sum of the units present in said polyamide.

In another embodiment, said at least one polyamide of the composition (2) comprises at least 70% of aliphatic units relative to the sum of the units present in said polyamide.

In another embodiment, said at least one polyamide of the composition (2) comprises at least 80% of aliphatic units relative to the sum of the units present in said polyamide.

In another embodiment, said at least one polyamide of the composition (2) comprises at least 90% of aliphatic units relative to the sum of the units present in said polyamide.

In another embodiment, said at least one polyamide of the composition (2) comprises 100% of aliphatic units relative to the sum of the units present in said polyamide. Said at least one polyamide therefore consists solely of aliphatic units.

In one embodiment, said composition (2) comprises predominantly a single polyamide and therefore said single polyamide is present in the composition in a proportion by weight of more than 50% relative to the total weight of the composition.

In one embodiment, said polyamide of said composition (2) comprises at least 60% of aliphatic units relative to the sum of the units present in said polyamide.

In another embodiment, said polyamide of said composition (2) comprises at least 70% of aliphatic units relative to the sum of the units present in said polyamide. In another embodiment, said polyamide of said composition (2) comprises at least 80% of aliphatic units relative to the sum of the units present in said polyamide.

In another embodiment, said polyamide of said composition (2) comprises at least 90% of aliphatic units relative to the sum of the units present in said polyamide.

In another embodiment, said polyamide of said composition (2) comprises 100% of aliphatic units relative to the sum of the units present in said polyamide. Said polyamide of said composition (2) therefore consists solely of aliphatic units.

In one embodiment, said layer (2) consists of a composition (2) comprising predominantly at least one long-chain polyamide having from 4 to 9 carbon atoms per nitrogen atom and comprising at least 50% of aliphatic units relative to the sum of the units present in said long-chain polyamide.

In one embodiment, said at least one polyamide of said composition (2) comprises at least 60% of aliphatic units relative to the sum of the units present in said polyamide. In another embodiment, said at least one polyamide of said composition (2) comprises at least 70% of aliphatic units relative to the sum of the units present in said polyamide.

In another embodiment, said at least one polyamide of said composition (2) comprises at least 80% of aliphatic units relative to the sum of the units present in said polyamide.

In another embodiment, said at least one polyamide of said composition (2) comprises at least 90% of aliphatic units relative to the sum of the units present in said polyamide.

In another embodiment, said at least one polyamide of said composition (2) comprises 100% of aliphatic units relative to the sum of the units present in said polyamide. Said polyamide of said composition (2) therefore consists solely of aliphatic units.

In one embodiment, said layer (2) consists of a composition (2) comprising predominantly a single polyamide and therefore said single polyamide is present in the composition in a proportion by weight of more than 50% relative to the total weight of the composition.

In one embodiment, said polyamide of said composition (2) comprises at least 60% of aliphatic units relative to the sum of the units present in said polyamide.

In another embodiment, said polyamide of said composition (2) comprises at least 70% of aliphatic units relative to the sum of the units present in said polyamide.

In another embodiment, said polyamide of said composition (2) comprises at least 80% of aliphatic units relative to the sum of the units present in said polyamide.

In another embodiment, said polyamide of said composition (2) comprises at least 90% of aliphatic units relative to the sum of the units present in said polyamide.

In another embodiment, said polyamide of said composition (2) comprises 100% of aliphatic units relative to the sum of the units present in said polyamide. Said polyamide therefore consists solely of aliphatic units.

Advantageously, in all the embodiments defined above for the composition (2) of the layer (2), the lactam is caprolactam, the amino acid is aminohexanoic acid, the diamine is chosen from 2-methyl-1,5-pentanediamine, 1,6-hexamethylenediamine, 1,7-heptanediamine, 1,8-octanediamine, 1,9-nonanediamine, 2-methyl-1,8-octanediamine, 2,2,4-trimethylhexamethylenediamine, 2,4,4-trimethylhexamethylenediamine and 1,10-decanediamine, and the dicarboxylic acid is chosen from adipic acid, sebacic acid, undecanedioic acid, dodecanedioic acid, brassylic acid and tetradecanedioic acid.

More advantageously, the lactam is caprolactam, the amino acid is aminohexanoic acid, the diamine is chosen from 2-methyl-1,5-pentanediamine, 1,6-hexamethylenediamine, 1,10-decanediamine and 1,12-dodecanediamine, and the dicarboxylic acid is chosen from adipic acid, sebacic acid and dodecanedioic acid.

In one embodiment, the lactam is caprolactam, the amino acid is aminohexanoic acid, the diamine is chosen from 2-methyl-1,5-pentanediamine, 1,6-hexamethylenediamine, 1,10-decanediamine and 1,12-dodecanediamine, and the dicarboxylic acid is chosen from adipic acid, sebacic acid and dodecanedioic acid.

Advantageously, said polyamide of said composition (2) comprises at least 60% of aliphatic units relative to the sum of the units present in said polyamide.

More advantageously, said polyamide of said composition (2) comprises at least 60% of aliphatic units relative to the sum of the units present in said polyamide and said long-chain polyamide of said composition (1) comprises at least 60% of aliphatic units relative to the sum of the units present in said long-chain polyamide.

Advantageously, said composition (2) is free from polyamide(s) other than aliphatic polyamide(s).

More advantageously, said polyamide of said composition (2) consists of aliphatic units.

In one embodiment, said polyamide of said composition (2) consists of aliphatic units and said long-chain polyamide of said composition (1) consists of aliphatic units.

Advantageously, said composition (2) and said composition (1) are free from polyamide(s) other than aliphatic polyamide(s).

Said composition (2) may also comprise at least one plasticizer in a proportion by weight of up to 2% relative to the total weight of the composition.

The plasticizer is as defined for composition (1).

Said composition (2) may also comprise at least one additive.

In one embodiment, the additive is in a proportion by weight of up to 2% relative to the total weight of the composition.

The additive is as defined for the composition (1).

In one embodiment, said composition (2) comprises by weight:
84% to 100%, in particular 90% to 100%, of at least one C4 to C9 polyamide as defined above;
0 to 12% of at least one polyolefin, in particular from 0 to 6% of at least one polyolefin;
0 to 2% of at least one plasticizer;
0 to 2% of at least one additive,
   the total being 100% by weight.

In another embodiment, said composition (2) is free from polyolefin and comprises by weight:
96% to 100% of at least one C4 to C9 polyamide as defined above;
0 to 2% of at least one plasticizer;
0 to 2% of at least one additive,
   the total being 100% by weight.

Advantageously, said composition (2) is free from plasticizer and said composition (2) comprises by weight:
86% to 100% of at least one C4 to C9 polyamide as defined above, in particular from 92% to 100% by weight;
0 to 12% of at least one polyolefin, in particular from 0 to 6% of at least one polyolefin;
0 to 2% of at least one additive,
   the total being 100% by weight.

It is quite obvious that the various compositions (2) comprising or not comprising at least one polyolefin and/or at least one plasticizer and/or at least one additive refer to all the embodiments described above for the composition (2).

In one embodiment, said at least one polyamide of the layer (2) of the tubular structure defined above is chosen from PA6, PA66, PA6/66, PA610, PA410, PA412 and PA612.

### With Regard to Layer (3) and Composition (3)

Said layer (3) comprising a composition (3) comprising predominantly a hydrophobic polymer, more particularly a polypropylene or a polyethylene, more particularly said layer (3) being located below said layer (2) or between said layer (1) and said layer (2).

This means that the composition (3) comprises more than 50% by weight of hydrophobic polymer, more particularly a polypropylene or a polyethylene, relative to its total weight.

According to one embodiment, the composition (3) may comprise at least 60% by weight, for example at least 70% by weight, for example at least 80% by weight, or even 100% by weight, of hydrophobic polymer, more particularly a polypropylene or a polyethylene, relative to its total weight.

According to one embodiment, the layer (3) comprises predominantly a composition (3), that is to say comprises more than 50% by weight, relative to its total weight, of a composition (3).

According to one embodiment, the layer (3) may comprise at least 60% by weight, for example at least 70% by weight, for example at least 80% by weight, or even 100% by weight, of composition (3).

The expression “hydrophobic polymer” is intended to mean a water barrier or partially barrier polymer. It may be an apolar polymer or a filled polymer in which the diffusion of water will be slower, for example a polyamide such as PA11 filled with graphene.

More specifically, a polymer is considered to be hydrophobic within the meaning of the invention when its coefficient of solubility relative to polar interactions (δp) is less than or equal to 5 MPa ½ and its coefficient of solubility relative to hydrogen bonds (δh) is less than or equal to 5 MPa ½ according to the Hansen solubility parameters (HANSEN SOLUBILITY PARAMETERS—A User's Handbook—second edition—Charles M.).

The hydrophobic polymer may be non-functionalized, as described in (B2) above, or functionalized as described in B1 above.

In one embodiment, the hydrophobic polymer is chosen from polypropylene and polyethylene.

The coefficient of solubility relative to polar interactions (δp) of polypropylene is less than 5 MPa ½ and its coefficient of solubility relative to hydrogen bonds (δh) is less than 5 MPa ½ according to the Hansen solubility parameters as defined above. Polypropylene is therefore indeed a hydrophobic polymer within the meaning of the present invention.

The coefficient of solubility relative to polar interactions (δp) of polyethylene is less than 5 MPa ½ and its coefficient of solubility relative to hydrogen bonds (δh) is less than 5 MPa ½ according to the Hansen solubility parameters as defined above. Polyethylene is therefore indeed a hydrophobic polymer within the meaning of the present invention.

Ethylene vinyl alcohol (or EVOH) is not considered to be a hydrophobic polymer within the meaning of the present invention.

The coefficient of solubility relative to polar interactions (δp) of ethylene vinyl alcohol is greater than 5 MPa ½ (it is between 10 and 15) and its coefficient of solubility relative to hydrogen bonds (δh) is greater than 5 MPa ½ (it is between 10 and 15) based on the Hansen solubility parameters as defined above.

In another embodiment, said polypropylene or said polyethylene is crosslinked.

Advantageously, said hydrophobic polymer of the layer (3) is chosen from a graft polypropylene, preferably grafted with maleic anhydride, and a graft high-density polyethylene (HDPE), preferably grafted with maleic anhydride.

In one embodiment, the MFI of the polypropylene or the polyethylene is from 0.5 to 10 g/10 min.

MFI, abbreviation for melt flow index, is the index of fluidity in the melt state. It is measured according to standard ASTM 1238 at 230° C. under 2.16 kg.

### With Regard to Layer (4) and Composition (4)

Said layer (4) is on the inside and is in contact with said fluid transported.

The layer (4) comprises a composition (4) comprising a PA6, a PA66 or a mixture thereof, from 5% to 50% by weight of at least one polyolefin, more particularly a functionalized polyolefin, preferably from 10% to 40% by weight of at least one polyolefin, up to 2% by weight of at least one plasticizer and up to 2% by weight of an additive, relative to the total weight of said composition, or a composition (4′) comprising predominantly at least one polyamide having from 8 to 14 carbon atoms per nitrogen atom and at least 20%, preferably at least 25% by weight of at least one polyolefin relative to the total weight of said composition (4′).

In one embodiment, said composition (4) comprises:
from 50 to 95% by weight of PA6, PA66 or a mixture thereof,
from 5 to 50% by weight of at least one polyolefin, more particularly a functionalized polyolefin, preferably from 10 to 40% by weight,
from 0 to 2% by weight of at least one plasticizer,
from 0 to 2% by weight of at least one additive.

In another embodiment, said composition (4) comprises:
from 60 to 90% of PA6, PA66 or a mixture thereof,
from 10 to 40% by weight of at least one polyolefin, more particularly a functionalized polyolefin,
from 0 to 2% by weight of at least one plasticizer,
from 0 to 2% by weight of at least one additive.

In a variant of these two embodiments, said composition (4) consists of the elements defined above for these two embodiments.

The plasticizers and the additives of the composition (4) are as defined for the composition (1).

The term “polyamide” of the composition (4′) denotes, in the same way, both a homopolyamide and a copolyamide.

The homopolyamide can be obtained from the polycondensation of lactam units, amino acid units or units XY, X being a diamine and Y a dicarboxylic acid (or diacid), from the point at which the homopolyamide has from 8 to 14 carbon atoms per nitrogen atom.

The diamine may be linear or branched aliphatic, or cycloaliphatic, and is preferably linear or branched aliphatic, in particular linear aliphatic.

The dicarboxylic acid may be aliphatic or cycloaliphatic, and preferably aliphatic.

Consequently, the lactams and amino acids used to obtain the homopolyamides must have an average number of carbon atoms (C) per nitrogen atom (N) of from 8 to 14.

Advantageously, the lactams and the amino acids are C11 and C12.

In the case of homopolyamides obtained from the polycondensation of units XY, the number of atoms per nitrogen atom is calculated by the average of the numbers of carbon atoms present in the unit derived from the diamine X and in the unit derived from the diacid Y.

Therefore, the diamine (X) can be C4 to C36, especially C6 to C18, more particularly C4 to C12, and the dicarboxylic acid (Y) can be C4 to C36, especially C6 to C18, more particularly C6 to C12, from the point at which the average of the numbers of carbon atoms present in the unit derived from the diamine X and in the unit derived from the diacid Y is from 10 to 15.

Advantageously, the diamine is chosen from 2-methyl-1,5-pentanediamine, 1,6-hexamethylenediamine, 1,7-heptanediamine, 1,8-octanediamine, 1,9-nonanediamine, 2-methyl-1,8-octane-diamine, 2,2,4-trimethylhexamethylenediamine, 2,4,4-trimethylhexamethylenediamine, 1,10-decanediamine, 1,11-undecanediamine, 2-butyl-2-ethyl-1,5-pentanediamine, 1,12-dodecanediamine, 1,13-tridecanediamine, 1,14-tetradecanediamine, 1,16-hexadecanediamine and 1,18-octadecanediamine.

Advantageously, the diamine is chosen from 1,10-decanediamine and 1,12-dodecanediamine.

Advantageously, the dicarboxylic acid is chosen from sebacic acid and dodecanedioic acid.

Advantageously, the diamine is chosen from 1,10-decanediamine and 1,12-dodecanediamine and the dicarboxylic acid is chosen from sebacic acid, undecanedioic acid and dodecanedioic acid.

In the case of copolyamides, the number of carbon atoms per nitrogen atom is calculated according to the same principle as for a homopolyamide. The calculation is carried out on a molar pro rata basis from the various amide units.

Consequently, the lactams and the amino acids used to obtain the copolyamides can have an average number of carbon atoms (C) per nitrogen atom (N) of from 6 to 15.

The diamines X and diacids Y used in the copolyamides may be aromatic diamines and/or diacids from the point at which said polyamide of the composition (4′) comprises at least 50% of aliphatic units relative to the sum of the units present in said polyamide.

In one embodiment, said at least one polyamide of the composition (4′) comprises at least 60% of aliphatic units relative to the sum of the units present in said polyamide.

In another embodiment, said at least one polyamide of the composition (4′) comprises at least 70% of aliphatic units relative to the sum of the units present in said polyamide.

In another embodiment, said at least one polyamide of the composition (4′) comprises at least 80% of aliphatic units relative to the sum of the units present in said polyamide.

In another embodiment, said at least one polyamide of the composition (4′) comprises at least 90% of aliphatic units relative to the sum of the units present in said polyamide.

In another embodiment, said at least one polyamide of the composition (4′) comprises 100% of aliphatic units relative to the sum of the units present in said polyamide. Said at least one polyamide of the composition (4′) therefore consists solely of aliphatic units.

In one embodiment, said composition (4′) comprises predominantly a single polyamide and therefore said single polyamide is present in the composition in a proportion by weight of more than 50% relative to the total weight of the composition.

In one embodiment, said polyamide of the composition (4′) comprises at least 60% of aliphatic units relative to the sum of the units present in said polyamide.

In another embodiment, said polyamide of the composition (4′) comprises at least 70% of aliphatic units relative to the sum of the units present in said polyamide. In another embodiment, said polyamide of the composition (4′) comprises at least 80% of aliphatic units relative to the sum of the units present in said polyamide.

In another embodiment, said polyamide of the composition (4′) comprises at least 90% of aliphatic units relative to the sum of the units present in said polyamide.

In another embodiment, said polyamide of the composition (4′) comprises 100% of aliphatic units relative to the sum of the units present in said polyamide. Said polyamide of the composition (4′) therefore consists solely of aliphatic units.

In one embodiment, said layer (4) consists of a composition (4′) comprising predominantly at least one long-chain polyamide having from 8 to 14 carbon atoms per nitrogen atom and comprising at least 50% of aliphatic units relative to the sum of the units present in said long-chain polyamide.

In one embodiment, said at least one polyamide of the composition (4′) comprises at least 60% of aliphatic units relative to the sum of the units present in said polyamide.

In another embodiment, said at least one polyamide of the composition (4′) comprises at least 70% of aliphatic units relative to the sum of the units present in said polyamide.

In another embodiment, said at least one polyamide of the composition (4′) comprises at least 80% of aliphatic units relative to the sum of the units present in said polyamide.

In another embodiment, said at least one polyamide of the composition (4′) comprises at least 90% of aliphatic units relative to the sum of the units present in said polyamide.

In another embodiment, said at least one polyamide of the composition (4′) comprises 100% of aliphatic units relative to the sum of the units present in said polyamide. Said polyamide therefore consists solely of aliphatic units.

In one embodiment, said layer (4) consists of a composition (4′) comprising predominantly a single polyamide and therefore said single polyamide is present in the composition in a proportion by weight greater than 50% relative to the total weight of the composition.

In one embodiment, said polyamide of the composition (4′) comprises at least 60% of aliphatic units relative to the sum of the units present in said polyamide.

In another embodiment, said polyamide of the composition (4′) comprises at least 70% of aliphatic units relative to the sum of the units present in said polyamide.

In another embodiment, said polyamide of the composition (4′) comprises at least 80% of aliphatic units relative to the sum of the units present in said polyamide.

In another embodiment, said polyamide of the composition (4′) comprises at least 90% of aliphatic units relative to the sum of the units present in said polyamide.

In another embodiment, said polyamide of the composition (4′) comprises 100% of aliphatic units relative to the sum of the units present in said polyamide. Said polyamide of the composition (1) therefore consists solely of aliphatic units.

Advantageously, in all the embodiments defined above for the composition (4′) of the layer (4), the lactam is chosen from lauryllactam, the amino acid is chosen from aminoundecanoic acid, the diamine is chosen from 1,8-octanediamine, 1,9-nonanediamine, 2-methyl-1,8-octanediamine, 2,2,4-trimethylhexamethylenediamine, 2,4,4-trimethylhexamethylenediamine, 1,10-decanediamine, 1,11-undecanediamine, 2-butyl-2-ethyl-1,5-pentanediamine and 1,12-dodecanediamine and the dicarboxylic acid is chosen from suberic acid, azelaic acid, sebacic acid, undecanedioic acid, dodecanedioic acid, brassylic acid and tetradecanedioic acid.

More advantageously, the lactam is lauryllactam, the amino acid is aminoundecanoic acid, the diamine is chosen from 1,10-decanediamine and 1,12-dodecanediamine, and the dicarboxylic acid is chosen from sebacic acid and dodecanedioic acid. Said composition (4′) of the layer (4) comprises at least 20% by weight, preferably at least 25% by weight of at least one polyolefin.

The polyolefin is as defined for the composition (1).

Said composition (4′) may also comprise at least one plasticizer and/or at least one additive.

The plasticizer and the additive are as defined above.

In one embodiment, said composition (4′) comprises by weight:
54% to 80% of at least one C8 to C14 polyamide as defined above, in particular 54% to 75%;
20 to 40%, preferably 25 to 40% of at least one polyolefin;
0 to 4% of at least one plasticizer;
0 to 2% of at least one additive,
   the total being 100% by weight.

The plasticizers and additives of the composition (4′) are as defined for the composition (1).

### Tubular Structure

The tubular structure may comprise at least one layer (1), at least one layer (2), at least one layer (3), and an inner layer (4).

The present invention also relates to a multilayer tubular structure (MLT) for transporting a heat transfer fluid, said multilayer tubular structure comprising:
at least one layer 1 comprising a composition 1 comprising predominantly at least one long-chain polyamide (PA) having from 10 to 15 carbon atoms per nitrogen atom and comprising at least 50% of aliphatic units relative to the sum of the units present in said long-chain polyamide,
at least one layer 2 located below said layer 1, comprising a composition 2 comprising predominantly at least one polyamide having from 4 to 9 carbon atoms per nitrogen atom, said polyamide comprising at least 50% of aliphatic units relative to the sum of the units present in said polyamide, more particularly said composition 2 comprising up to 12% by weight of polyolefins, in particular up to 6% by weight of polyolefin, relative to the total weight of said composition 2, and up to 2% by weight of at least one plasticizer, relative to the total weight of said composition 2,
at least one layer 3 comprising a composition 3 comprising predominantly a hydrophobic polymer, more particularly a polypropylene or a polyethylene, more particularly said layer 3 being located below said layer 2 or between said layer 1 and said layer 2,
a layer 4 comprising either a composition 4 comprising a PA6, a PA66 or a mixture thereof, from 5% to 50% by weight of at least one polyolefin, more particularly a functionalized polyolefin, preferably from 10% to 40% by weight of at least one polyolefin, up to 2% by weight of at least one plasticizer and up to 2% by weight of an additive, relative to the total weight of said composition 4
or a composition 4′ comprising predominantly at least one C8-C14 aliphatic polyamide,
said layer 4 in contact with said fluid transported,
a layer 5 being present between said layer 3 and said layer 4, said layer 5 comprising a composition 2 and the thicknesses of said layer(s) 2 and 5 representing at least 70% of the total thickness of the tube.

In one embodiment, the thickness of said layer (2) is more particularly up to 90% of the total thickness of the tube, in particular up to 80% of the total thickness of the tube.

In one embodiment, said multilayer tubular structure as defined above is characterized in that said layer (2) is free from plasticizer.

In another embodiment, said multilayer tubular structure as defined above is characterized in that said layer (2) and said layer (1) are free from plasticizer.

In yet another embodiment, said multilayer tubular structure as defined above is characterized in that all the layers present in said structure are free from plasticizer.

In one embodiment, said structure comprises a layer (5) between said layer (3) and said layer (4), said layer (5) comprising a composition (2) and the thicknesses of said layer(s) (2) and (5) representing at least 80% of the total thickness of the tube.

The layers (2) and (5) may be identical or different.

In one embodiment, said multilayer tubular structure defined above is characterized in that said layer (1) is the outermost layer of said multilayer tubular structure.

According to a first variant, said tubular structure is characterized in that it consists of four layers (1)//(2)//(3)//(4) or (1)//(3)//(2)//(4).

According to a second variant, said tubular structure is characterized in that it consists of five layers (1)//(2)//(3)//(5)//(4) or (1)//(3)//(2)//(5)//(4).

In one embodiment, the multilayer tubular structure as defined above is characterized in that the heat transfer fluid is a refrigerant fluid chosen from hydrocarbon compounds, hydrofluorocarbons, ethers, hydrofluoroethers, CO₂, NH₃, SO₂ and fluoroolefins.

In one embodiment, the heat transfer fluid is a refrigerant fluid chosen from CO₂, fluoropropenes, fluoropropanes and fluoroethanes, preferably from 1,3,3,3-tetrafluoropropene, 2,3,3,3-tetrafluoropropene, 1,2,3,3,3-pentafluoropropene, 1,1,3,3-tetrafluoropropene, 3,3,3-trifluoropropene, 2,3,3-trifluoropropene, 1,1,1,2-tetrafluoroethane, 1,1,2,2-tetrafluoroethane, pentafluoroethane, difluoromethane, 1,1-difluoroethane, 1,1,1,2,3,3,3-heptafluoropropane, 1,1,1-trifluoropropane, 1,1,1,3,3,3-hexafluoropropane, 1,1,1,3,3-pentafluoropropane, 1,1,1,3,3-pentafluorobutane, trifluoroiodomethane and mixtures comprising the same.

In one embodiment, the heat transfer fluid is a refrigerant fluid chosen from 1,3,3,3-tetrafluoropropene (1234ze) and 2,3,3,3-tetrafluoropropene (1234yf); more particularly, the heat transfer fluid is 2,3,3,3-tetrafluoropropene (1234yf).

Advantageously, the refrigerant fluid contains a lubricant, preferably chosen from mineral oils, silicone oils, paraffins of natural origin, naphthenes, synthetic paraffins, alkylbenzenes, poly-alpha-olefins, polyalkylene glycols, polyol esters and/or polyvinyl ethers, the lubricant being more particularly preferably a polyalkylene glycol or a polyol ester.

According to another aspect, the present invention relates to the use of a multilayer tubular structure as defined above, for transporting a heat transfer fluid, more particularly a refrigerant fluid chosen from hydrocarbon compounds, hydrofluorocarbons, ethers, hydrofluoroethers, CO₂, NH₃, SO₂ and fluoroolefins, in particular R134, R-1234yf or R-1234ze, more particularly R-1234yf or R-1234ze in the field of automotive air conditioning.

According to yet another aspect, the present invention relates to the use of a multilayer tubular structure as defined above, to satisfy an extractables test, said test consisting in particular of filling said multilayer tubular structure MLT with forane and in heating the assembly at 60° C. for 96 hours, then emptying it by filtering it into a beaker, then allowing the filtrate in the beaker to evaporate at room temperature and finally weighing this residue, the proportion of which must be less than or equal to about 6 g/m² of internal tube surface area, and the proportion of residue on the filter after filtration being less than or equal to 1 g/m², preferably less than or equal to 0.5 g/m².

In other words, the present invention relates to the use of a multilayer tubular structure as defined above, to reduce the proportion of soluble and insoluble compound released by a tubular structure, as defined above, after said multilayer tubular structure MLT has been brought into contact with forane, said proportion of compound released being determined by an extractables test, said test consisting in particular of filling said multilayer tubular structure MLT with forane and heating the assembly at 60° C. for 96 hours, then emptying it by filtering it into a beaker, then allowing the filtrate of the beaker to evaporate at room temperature and finally weighing this residue, the proportion of which must be less than or equal to about 6 g/m² of internal tube surface area, and the proportion of residue on the filter after filtration being less than or equal to 1 g/m², preferably less than or equal to 0.5 g/m².

Said tubular structure therefore makes it possible to reduce the proportion of soluble and insoluble compound after contact with the forane, relative to the structures of the prior art.

EXAMPLES

The present invention will now be illustrated with the aid of examples, though without being limited to these examples.

The following structures were prepared by extrusion:

The multilayer tubes are produced by coextrusion. A McNeil industrial multilayer extrusion line is used, equipped with 5 extruders, connected to a multilayer extrusion head with spiral mandrels.

The screws used are single extrusion screws having screw profiles suited to polyamides. In addition to the 5 extruders and the multilayer extrusion head, the extrusion line includes:
a die-punch assembly, located at the end of the coextrusion head; the internal diameter of the die and the external diameter of the punch are chosen according to the structure to be produced and the materials of which it is composed, as well as the dimensions of the tube and the line speed;
a vacuum tank with an adjustable level of vacuum. Water generally maintained at 20° C. circulates in this tank, in which a gauge is immersed that makes it possible to shape the tube in its final dimensions. The diameter of the gauge is adapted to the dimensions of the tube to be produced, typically from 8.8 to 11 mm for a tube with an internal diameter of 6 mm and a thickness of 1.3 mm;
a succession of cooling tanks in which water is maintained at around 20° C., allowing the tube to be cooled along the path from the head to the drawing stand;
a diameter measurer;
a drawing bench.

The configuration having 5 extruders is used to produce tubes ranging from 2 layers to 5 layers. In the case of the structures in which the number of layers is less than 5, several extruders are then fed with the same material.

In the case of the structures comprising 6 layers, an additional extruder is connected and a spiral mandrel is added to the existing head, with a view to producing the inner layer in contact with the fluid.

Before the trials, in order to ensure the best properties of the tube and a good quality of extrusion, it is verified that the extruded materials have a residual moisture content before extrusion of less than 0.08%. In the opposite case, an additional step of drying the material is carried out before the trials, generally in a vacuum dryer, overnight at 80° C.

The tubes, which correspond to the characteristics described in the present patent application, were removed, after stabilization of the extrusion parameters, the dimensions of the tube in question no longer changing over time. The diameter is monitored by a laser diameter measurer installed at the end of the line.

Generally, the line speed is typically 20 m/min. It generally varies between 5 and 100 m/min.

The screw speed of the extruders depends on the thickness of the layer and the diameter of the screw, as is known to those skilled in the art.

In general, the temperatures of the extruders and of the tools (head and coupling) must be adjusted so as to be sufficiently higher than the melting temperature of the compositions in question, so that they remain in the melt state, thus preventing them from solidifying and blocking the machine.

Tubular structures with the following polymers:
P1: PA6 +35% by weight of Orevac® IM 800 (maleic anhydride-modified HDPE (SK Functional Polymer))
P2: PA11 Rilsan® BESN Black TL P024 (Arkema)
P3: PA612 +20% by weight of Orevac® IM 800 (maleic anhydride-modified HDPE (SK Functional Polymer))
P4: PP-g-MAH (maleic anhydride-grafted polypropylene) Admer QB509E (Mitsui)
P5: HDPE-g-MAH (maleic anhydride-grafted high-density polyethylene) obtained by making a mixture of 93% by weight of XRT70 PERT type II (Total Energy) and 7% by weight of Orevac OE25 (SK Functional Polymers)
P6: EVOH Eval 171B (Kuraray)
P7: PA6 +10% by weight of Orevac® IM 800 (maleic anhydride-modified HDPE (SK Functional Polymer))
   were tested for various parameters, shown in Table 1.

TABLE 1

| | | | Water | | |
|---|---|---|---|---|---|
| | | | flow** | | |
| | | Bursting | g/m² · 24 h at | | |
| | Description of the structure | stress at | 70° C. 100% | Flow of | Resistance |
| | (ext -> int) | 125° C. | RH | R1234yf*** | to ZnCl₂**** |
| CE1 | P3 monolayer | 15 | 19 | C | 2 |
| CE2 | P2 monolayer | 10 | 15 | C | 1 |
| CE3 | P1 monolayer | 7.5 | 54 | C | 3 |
| CE4 | P4 monolayer | 1.8 | 4.6 | B | 1 |
| CE5 | P2/P3 | 7.9 | 23 | C | 1 |
| | 150 μm/1150 μm | | | | |
| CE6 | P2/P6/P3/P1 | 11.8 | 28.5 | C | 1 |
| | 100 μm/150 μm/1000 μm/50 μm | | | | |
| CE7 | P2/P4/P3/P1 | 9.3 | 10 | C | 1 |
| | 150 μm/400 μm/650 μm/100 μm | | | | |
| EI1 | P2/P4/P3/P1 | 12.9 | 15 | C | 1 |
| | 100 μm/150 μm/1000 μm/50 μm | | | | |
| EI2 | P2/P5/P3/P1 | 12.6 | 15 | C | 1 |
| | 100 μm/150 μm/1000 μm/50 μm | | | | |
| EI3 | P2/P3/P5/P3/P1 | 13 | 16 | C | 1 |
| | 40 μm/950 μm/150 μm/110 μm/50 μm | | | | |
| EI4 | P2/P7/P5/P7/P1 | 14.3 | 22 | C | 1 |
| | 40 μm/950 μm/150 μm/110 μm/50 μm | | | | |

### CE 1 to 7: Counter-Examples

The counter-examples have either too high a permeability to water, that is to say have a flow greater than or equal to 23 g/m²0.24 h, or too low a bursting stress, that is to say a stress less than 12 MPa, or are not barriers to the flow of R1234yf, that is to say have A or B classification, or have a low resistance in contact with zinc chloride, that is to say have a classification of 2 or 3.

### EI1 to EI4: Example According to the Invention

Only the four-layer structures according to the invention show a good trade-off on the four evaluated criteria such as bursting pressure greater than 12 MPa, barrier properties to air conditioning fluid (R1234yf) (classification C), resistance to zinc chloride (classification 1) and permeability to water, with a flow of less than 23 g/m²0.24 h, compared to the counter-examples, which do not allow a combination of good performances on the 4 evaluation criteria.

The tests used are detailed in Table 2.

TABLE 2

| (*) Bursting stress in MPa of a tube | Values specified in the table above | | |
|---|---|---|---|
| at 125° C. conditioned under 50% | | | |
| water for 15 days (according to DIN | | | |
| 53758 SAE J3062). Dimensions 8 × | | | |
| 1.3 mm | | | |
| (**) Water permeability. Obtained | Values specified in the table above | | |
| from WVTR (water vapour | | | |
| transmission rate) measurement | | | |
| according to the materials test | | | |
| method D45.1720 of PSA Peugeot | | | |
| Citroën performed on 8 × 1.3 mm | | | |
| tubes. | | | |
| Condition 70° C., 100% relative | | | |
| humidity [g/m² · 24 h] | | | |
| | Classification C | Classification B | Classification A |
| (***) Air conditioning fluid barrier. | <1.5 | >1.5 and <4 | >4 and <10 |
| Trial carried out on 1.3 mm thick | | | |
| tube with 8 mm external diameter. | | | |
| Heat insulation fluid: R-1234yf | | | |
| Temperature: 80° C. | | | |
| Unit: kg/m²/year | | | |
| Classification according to standard | | | |
| GMW 14319 | | | |
| | 1 | 2 | 3 |
| (****) Resistance to ZnCl2. A tube | >200 h. | <200 h and >1 h. | <1 h |
| with an external diameter of 8 mm | | | |
| and a thickness of 1.3 mm is | | | |
| deformed to 30% (with maintenance | | | |
| of the stress) in an aqueous solution | | | |
| containing at 50% by weight a | | | |
| mixture containing respectively 30% | | | |
| by weight of CuCl₂, 20% by weight of | | | |
| NaCl, 20% by weight of KCl and 30% | | | |
| by weight of ZnCl₂ (according to | | | |
| standard ISO 7628) | | | |
| Analysis of the outer layer of the | | | |
| structures and of the bursting | | | |
| pressure | | | |

1. A multilayer tubular structure (MLT) for transporting a heat transfer fluid, said multilayer tubular structure comprising:
at least one layer (1) comprising a composition (1) comprising predominantly at least one long-chain polyamide (PA) having from 10 to 15 carbon atoms per nitrogen atom and comprising at least 50% of aliphatic units relative to the sum of the units present in said long-chain polyamide,
at least one layer (2) located below said layer (1), comprising a composition (2) comprising predominantly at least one polyamide having from 4 to 9 carbon atoms per nitrogen atom, said polyamide comprising at least 50% of aliphatic units relative to the sum of the units present in said polyamide,
at least one layer (3) comprising a composition (3) comprising predominantly a hydrophobic polymer,
a layer (4) comprising either a composition (4) comprising a PA6, a PA66 or a mixture thereof, from 5% to 50% by weight of at least one polyolefin, up to 2% by weight of at least one plasticizer and up to 2% by weight of an additive, relative to the total weight of said composition (4)
or a composition (4′) comprising predominantly at least one C8-C14 aliphatic polyamide,
said layer (4) in contact with said fluid transported,
and the thickness of said layer or layers (2) representing at least 70% of the total thickness of the tube.

2. The multilayer tubular structure as claimed in claim 1, wherein a layer (5) is present between said layer (3) and said layer (4), said layer (5) comprising a composition (2) and the thicknesses of said layer(s) (2) and (5) representing at least 80% of the total thickness of the tube.

3. The multilayer tubular structure as claimed in claim 1, wherein said layer (1) is the outermost layer of said multilayer tubular structure.

4. The multilayer tubular structure as claimed in claim 1, wherein said composition (1) comprises up to 40% by weight of at least one polyolefin.

5. The multilayer tubular structure as claimed in claim 1, wherein said composition (1) comprises at least 3% by weight of at least one polyolefin, relative to the total weight of said composition (1).

6. The multilayer tubular structure as claimed in claim 1, said composition (1) comprising up to 8% by weight of at least one plasticizer relative to the weight of said composition (1).

7. The multilayer tubular structure as claimed in claim 1, wherein the heat transfer fluid is a refrigerant fluid chosen from hydrocarbon compounds, hydrofluorocarbons, ethers, hydrofluoroethers, CO₂, NH₃, SO₂ and fluoroolefins.

8. The multilayer tubular structure as claimed in claim 7, wherein the heat transfer fluid is a refrigerant fluid chosen from CO₂, fluoropropenes, fluoropropanes and fluoroethanes, and mixtures comprising the same.

9. The multilayer tubular structure as claimed in claim 7, wherein the heat transfer fluid is a refrigerant fluid chosen from 1,3,3,3-tetrafluoropropene (1234ze) and 2,3,3,3-tetrafluoropropene (1234yf).

10. The multilayer tubular structure as claimed in claim 7, wherein the refrigerant fluid contains a lubricant.

11. The multilayer tubular structure as claimed in claim 1, wherein said at least one polyamide of the layer (1) is chosen from PA11, PA12, PA1010, PA1210 and PA1212.

12. The multilayer tubular structure as claimed in claim 1, wherein said at least one polyamide of the layer (2) is chosen from PA6, PA66, PA6/66, PA610,PA410, PA412 and PA612.

13. The multilayer tubular structure as claimed in claim 1, wherein said at least one hydrophobic polymer of the layer (3) is chosen from a graft polypropylene and a graft high-density polyethylene (HDPE).

14. The multilayer tubular structure as claimed in claim 1, wherein the structure consists of four layers (1)//(2)//(3)//(4) or (1)//(3)//(2)//(4).

15. The multilayer tubular structure as claimed in claim 1, wherein the structure consists of five layers (1)//(2)//(3)/(5)//(4) or (1)//(3)//(2)/(5)//(4).

16. A method comprising transporting a heat transfer fluid in the multilayer tubular structure as defined in claim 1.

17. A method comprising using a multilayer tubular structure as claimed in claim 1, to satisfy an extractables test, said test comprising filling said multilayer tubular structure MLT with forane and in heating the assembly at 60° C. for 96 hours, then emptying it by filtering it into a beaker, then allowing the filtrate in the beaker to evaporate at room temperature and finally weighing this residue, the proportion of which must be less than or equal to about 6 g/m² of internal tube surface area, and the proportion of residue on the filter after filtration being less than or equal to 1 g/m².
